(19) United States
(12) Patent Application Publication
(10) Pub. No.: US 2007/0243356 A1
(43) Pub. Date: Oct. 18, 2007

(54) SELF FOLDING LOW-PROFILE TEXTILE SLEEVE FOR PROTECTING ELONGATE MEMBERS AND METHOD OF CONSTRUCTION

(76) Inventors: Angela L. Baer, Westminster, MD (US); G. Christopher Thierolf, Abington, PA (US)

Correspondence Address: ROBERT L. STEARNS;Dickinson Wright PLLC, Ste. 2000, 38525 Woodward Avenue, Bloomfield Hills, MI, 48304-2970, US

(21) Appl. No.: 11/696,844

(22) Filed: Apr. 5, 2007

Related U.S. Application Data
(60) Provisional application No. 60/792,523, filed on Apr. 17, 2006.

(51) Int. Cl. B32B 3/04; B32B 3/06

(52) U.S. Cl. 428/99; 428/121

(57) ABSTRACT

A woven low-profile protection sleeve has a lower wall hingedly connected to an upper wall. The lower wall and upper wall have a plurality of yarn filaments extending along a warp direction corresponding to the length of the sleeve and a plurality of yarn filaments extending along a generally perpendicular fill direction. The upper wall is interconnected with the lower wall via a living hinge that utilizes at least some of the same yarn filaments forming the upper and lower walls. The living hinge provides self folding movement between the upper and lower walls to bias them in overlapping relation to one another. An additional aspect includes providing at least some of the yarn filaments in the upper wall, lower wall, and living hinge as being conductive to provide the sleeve with at least one of EMI, RFI or ESD shielding properties.

### CROSS-REFERENCE TO RELATED APPLICATION

This application claims priority to U.S. Provisional Application Ser. No. 60/792,523, filed Apr. 17, 2006, which is incorporated herein by way of reference in its entirety.

### BACKGROUND OF THE INVENTION

1. Technical Field

This invention relates generally to sleeves for protecting elongate members and more particularly to low-profile, generally flat textile sleeves for protecting elongate members.

2. Related Art

The use of fabric sleeves for protecting elongate members, such as wires or hoses, for example, is known. Typically, the sleeves are either tubular and fully enclosed, wherein the elongate members are inserted into the sleeves through an open end thereof, or they are initially open and generally flat, such that the elongate members are set onto a flat surface thereof, and then subsequently manually rolled or folded over and fastened, such as via an adhesive, tape or hook and loop fasteners, to maintain the sleeve in a closed configuration about the elongate members.

It is also known that electromagnetic interference (EMI), radio frequency interference (RFI), and electrostatic discharge (ESD) pose a potential problem to proper functioning of electronic components caused by interference due to inductive coupling between nearby electrical conductors and propagating electromagnetic waves. For example, electrical currents in conductors associated with an electrical power system, such as in an automobile, may induce spurious signals in various electronic components, such as an electronic module which controls the functioning of the engine. Such interference could downgrade the performance of control modules or other electrical components in the vehicle, thereby causing the vehicle and/or its electrical components to act other than as desired. Similarly, inductive coupling between electrical wiring and the lines carrying data in a computer network or other communication system may have a corrupting effect on the data being transmitted over the network.

Accordingly, it is known to incorporate shielding and grounding within the sleeves discussed above to effectively eliminate the potentially adverse effects caused by EMI, RFI and ESD. For example, wires carrying control signals which may be subjected to unwanted interference may be shielded by using a protective sleeve formed from electrically conductive and non-conductive constituents, with the conductive constituents typically being grounded via a drain wire interlaced with the yarns during manufacture of the sleeve.

While such RFI, EMI, and ESD sleeving is generally effective at eliminating electrical interference, when an open sleeve is used, as described above, secondary operations are required to enclose the elongate members for protection within the sleeve. Secondary operations decrease manufacturing and assembling efficiencies, increases component cost, and thus, increases the overall cost associated with the manufacture and assembly of the sleeve.

A sleeve manufactured according to the present invention overcomes or greatly minimizes any limitations described above, thereby allowing elongate members to be readily disposed for protection in sleeves without incurring costly secondary operations, added materials, and labor.

### SUMMARY OF THE INVENTION

A woven sleeve having a low-profile for protecting generally flat elongate members has a generally flat lower wall hingedly connected to a generally flat upper wall. The lower wall is woven with a plurality of yarn filaments extending along a warp direction corresponding to a length of the sleeve and a plurality of yarn filaments extending along a fill direction generally perpendicular to the warp direction. The upper wall is woven as one piece with the lower wall using at least some of the same yarn filaments forming the lower wall. The upper wall has a plurality of yarn filaments extending along a warp direction corresponding to a length of the sleeve and a plurality of yarn filaments extending along a fill direction generally perpendicular to the warp direction. A living hinge is constructed at least in part from at least some of the same yarn filaments forming the lower and upper walls, with the living hinge integrally connecting the lower wall to the upper wall as one piece of material to provide self folding movement between the lower and upper walls by biasing the lower and upper walls in overlapping relation to one another. Also, in accordance with an additional aspect of the invention, at least some of the yarn filaments in the upper wall, lower wall, and living hinge can be formed with conductive material to provide the sleeve with at least one of EMI, RFI or ESD shielding properties.

Another aspect of the invention includes a method of constructing a sleeve having generally flat lower and upper walls overlying one another in a generally low-profile for protecting generally flat elongate members against at least one of abrasion, high temperatures, EMI, RFI or ESD. The method includes; weaving a plurality of yarn filaments extending along a warp direction corresponding to a length of the sleeve and a plurality of yarn filaments extending along a fill direction generally perpendicular to said warp direction with one another, and forming a living hinge with at least some of the yarn filaments during the weaving step, with the living hinge connecting the lower and upper walls together and biasing the walls into self folding movement in overlapping relation with one another. Also, in accordance with an additional aspect of the invention, at least some of the yarn filaments can be formed with conductive material to provide the sleeve with EMI, RFI or ESD shielding properties. Yet another aspect can include interlacing a drain wire into one of the lower or upper walls to enhance the EMI, RFI or ESD shielding properties. Further yet, a coating can be applied over an outer surface of the sleeve to enhance its abrasion resistance, thermal resistance, EMI, RFI and/or ESD shielding properties.

Accordingly, low-profile sleeves having overlapping walls connected to one another by a living hinge providing self-folding movement of the walls in accordance with the invention are useful for protecting generally flat elongate members from at least one of abrasion, thermal affects, EMI, RFI or ESD, in an effective and economical manner. The sleeves can be made to accommodate virtually any package size by adjusting the fabricated width, height, and length of the walls in manufacture, and can be equipped with a variety of closure mechanisms, if desired, to further secure the elongate members in the sleeves.

### BRIEF DESCRIPTION OF THE DRAWINGS

These and other objects, features and advantages will become readily apparent to those skilled in the art in view of the following detailed description of the presently preferred embodiments and best mode, appended claims, and accompanying drawings, in which:

FIG. 1 is a top fragmentary perspective view of a low-profile sleeve constructed according to one presently preferred embodiment of the invention shown in a closed position;

FIG. 2 is a view similar to FIG. 1 shown in an open position;

FIG. 3 is a schematic end view of the sleeve of FIG. 1 shown in a closed position;

FIG. 4 is a top fragmentary perspective view of a low-profile sleeve constructed according to another presently preferred embodiment of the invention shown in an open position;

FIG. 5 is a chart illustrating a weave pattern for the sleeve of FIG. 1;

FIG. 6 is a schematic end view of the sleeve of FIG. 1 illustrating different portions of the sleeve in the open position; and

FIG. 7 is a schematic plan view of the sleeve of FIG. 1 shown in an open and flattened configuration.

### DETAILED DESCRIPTION OF PREFERRED EMBODIMENTS

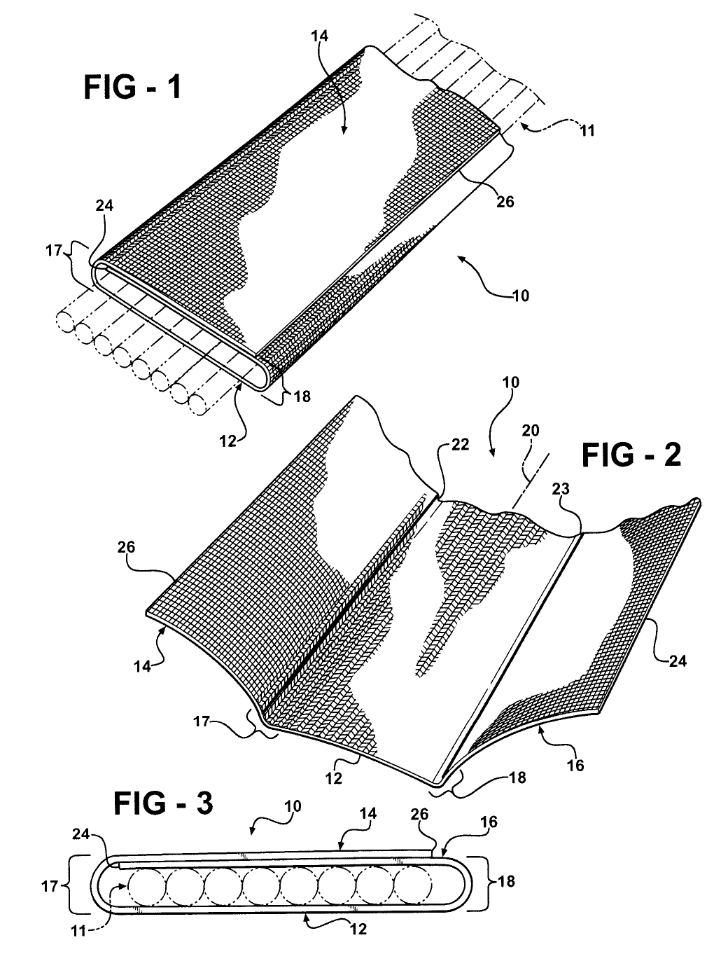

Referring in more detail to the drawings, FIGS. 1-3 illustrate a low-profile, generally flat textile sleeve 10 constructed in accordance with one presently preferred embodiment of the invention. The sleeve 10 can be used for protecting elongate members, such as generally flat tubing or a generally flat bundle of wires 11, for example. The sleeve 10 has a plurality of walls, represented here, by way of example and without limitations, as a lower wall 12, an upper wall 14 and an intermediate wall 16, arranged in operable communication with one another. The walls 12, 14, 16 provide the type of protection desired, such as resistance to abrasion, thermal protection, fluid protection, EMI shielding, RFI shielding and/or ESD shielding, to the elongate members contained with the sleeve 10. At least a pair of the walls are connected to one another via a living hinge portion, with the embodiments illustrated having the lower wall 12 interconnected with the upper and intermediate walls 14, 16 via living hinge regions 17, 18, respectively. The living hinge regions 17, 18 impart a bias on the respective upper and intermediate walls 14, 16 to bring them into overlapping relation with one another and with the lower wall 12. The upper and intermediate walls 14, 16 can be unfolded relative to the lower wall 12 to an open position (FIG. 2) by applying an external force sufficient to overcome the bias of the respective living hinge regions 17, 18, thereby allowing the elongate members 11 to be inserted laterally toward a longitudinal axis 20 into the sleeve 10, or remove therefrom, as desired. Upon inserting the elongate members 11 into the sleeve 10, the external force can be removed from the upper and intermediate walls 14, 16, thus, allowing the upper and intermediate walls 14, 16 to return to their biased, generally flat overlapping positions with the lower wall 12. As such, the elongate members 11 are contained within the sleeve 10 between the lower wall 12 and intermediate wall 16, with the upper wall 14 overlying the intermediate wall 16 to fully enclose the elongate members 11 and provide the type of protection desired, depending on the types of yarn used in fabricating the walls 12, 14, 16.

The lower, upper and intermediate walls 12, 14, 16 are woven with a plurality of yarn filaments extending along a warp direction corresponding to a length of the sleeve 10 and a plurality of yarn filaments extending along a fill direction generally perpendicular to the warp direction. The upper and intermediate walls 14, 16 are woven with at least some of the same yarn filaments as the lower wall 12, wherein the yarns common to the walls 12, 14, 16 traverse the living hinge regions 17, 18. The yarn filaments are preferably provided as multi-filamentary yarns, though monofilaments could be used, particularly in the warp direction, if desired. Depending on the performance requirements of the application, the yarn can be formed from, by way of example and without limitations, polyester, nylon, polypropylene, polyethylene, acrylic, cotton, glass, rayon, and fire retardant (FR) versions of all the aforementioned materials. If even higher temperature ratings are desired along with FR capabilities, then some presently preferred non-conductive filamentary members include m-Aramid (Nomex, Conex, Kermel), p-Aramid (Kevlar, Twaron, Technora), PEI (Ultem), PPS, and PEEK, for example.

The living hinge regions 17, 18 are constructed in a manner to bias the respective walls 12, 14, 16 into an overlapping, generally flat relation with one another. The hinge regions 17, 18 are constructed at least in part from yarn filaments which are common to the interconnected walls. The bias imparted by the hinge regions 17, 18 is created by altering the weave pattern within the hinge regions 17, 18, such that a tensile force is established across pivot locations 22, 23 of the respective hinge regions 17, 18 to bias the interconnected walls 12, 14, 16 into their overlapping relation. As such, the bias is imparted by the nature of the weaving within the hinge regions 17, 18, and not by performing secondary operations on the sleeve 10, such as heat-setting, for example.

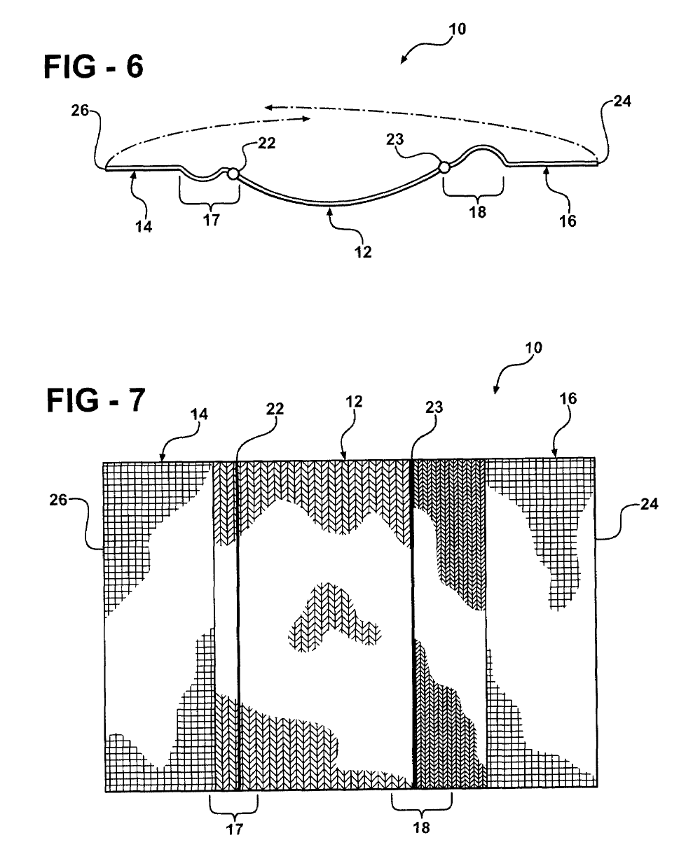

As best demonstrated in a weave pattern diagram, FIG. 5 illustrates the type of weave patterns used for the lower wall 12, the hinge regions 17, 18 interconnecting the lower wall 12 to the adjacent walls 14, 16, and the pivot locations 22, 23, while FIG. 6 illustrates schematically the general location of the various weave patterns.

The intermediate wall 16 extends from an edge 24 to the hinge region 17 that interconnects the intermediate wall 16 to the lower wall 12. The intermediate wall 16 is formed using a balance weave pattern, such as a basket weave, also referred to as a plain weave, or from a twill weave, as schematically illustrated. With the yarns of the intermediate wall 16 being woven in a balanced weave pattern, wherein the number of fill and warp directed yarns exposed to opposite surfaces is the same, the intermediate wall takes on a generally flat shape, as no bias in imparted over its surface.

The hinge region 18 extends across the pivot location 23 from the intermediate wall 16 to the lower wall 12, wherein the hinge region 18 has at least one, and illustrated here as a pair of different imbalanced weave patterns, such as a satin weave or a herringbone weave, as illustrated. The herringbone weave patterns of the hinge region 18 are woven both as a warp-faced herringbone weave pattern adjacent the intermediate wall 16 on one side of the pivot location 23, and as a fill or weft-faced herringbone weave pattern on the opposite side of the pivot location 23. As such, the imbalanced warp and weft-faced weaves on opposite sides of the pivot location 23 act to bias the intermediate wall 16 and the lower wall 12 into a folded position overlying one another. To facilitate the self-folding action, the pivot location 23 within the hinge region 18 is formed of a less dense weave pattern comprising only a two ends of yarn, for example, woven in a balance weave pattern, such as a plain weave or twill weave, as illustrated. It should be recognized that the weave pattern of the hinge region 18 may extend along a portion of the intermediate wall 16.

The lower wall 12 extends from the hinge region 18 to the opposite hinge region 17, and is represented here, by way of example and without limitation, as being woven in the same weft-faced weave pattern as used in the hinge region 18. Accordingly, the lower wall 12 and the adjacent portions of the hinge regions 17, 18 are able to be woven using the same weave pattern and yarns, and thus, portions of the hinge regions 17, 18 are formed as an extension of the lower wall 12.

The hinge region 17, as mentioned, is formed in part as an extension of the lower wall 12, and extends across the pivot location 22 to a remaining portion of the hinge region 17 that is attached upper wall 14. The pivot location 22 is constructed to facilitate folding of the hinge region 17, and thus, is woven generally the same as discussed above for the pivot location 23. Accordingly, the pivot location 22 is comprised of a less dense and balanced weave pattern than the adjacent portions of the hinge region 17. The portion of the hinge region between the pivot location 22 and the upper wall 14 is woven in an imbalanced weave pattern, and is illustrated here as being woven utilizing the same weft-faced herringbone weave pattern as used to form the hinge region 17 on the opposite side of the pivot location 22. Accordingly, unlike the hinge region 18 that has different imbalanced weave patterns on opposite side of its associated pivot location 23, the hinge region 17 utilizes the same imbalanced weave pattern on opposite sides of its associated pivot location 22.

The upper wall 14 extends from the hinge region 17 to an edge 26. The upper wall 14 is formed generally the same as the intermediate wall 16, and thus, has a balance weave pattern, such as a basket weave or a twill weave, as schematically illustrated. As with the intermediate wall 16, the upper wall 14 takes on a generally flat shape, as no bias in imparted over its surface.

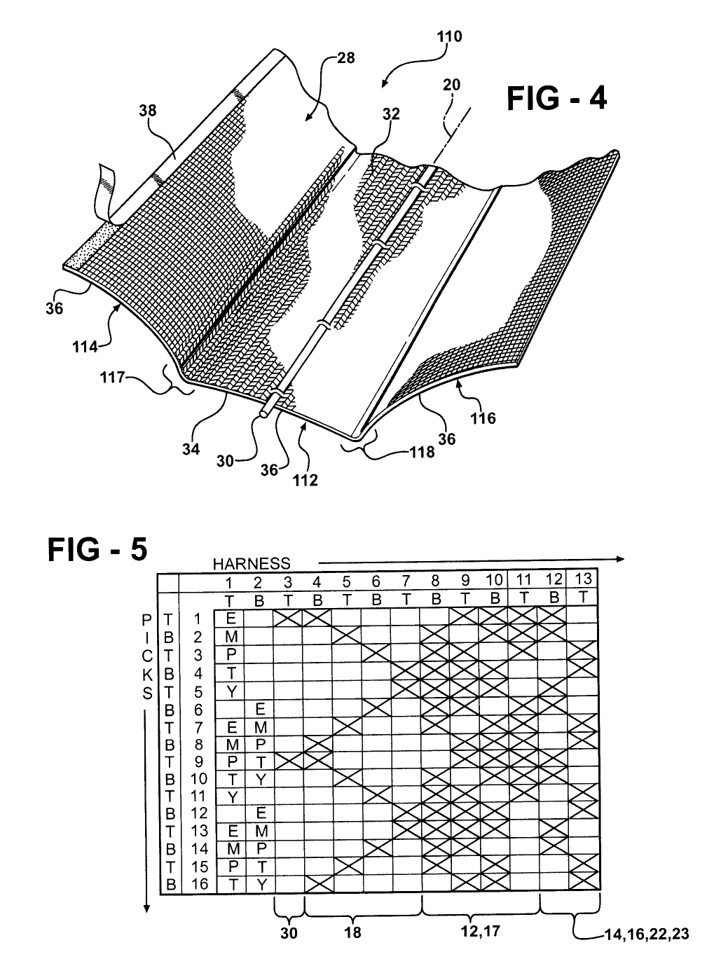

In FIG. 4, another sleeve constructed in accordance with the invention is shown generally at 110. The sleeve 110 is constructed similarly as the previous embodiment, and thus, reference numerals offset by 100 are used to identify like features. The sleeve 110 has lower, upper and intermediate walls 112, 114, 116, woven at least in part from conductive yarns identified generally by 28, preferably in both the fill and warp directions. The conductive yarns 28 extend across hinge regions 117, 118, and thus, the conductive yarns are preferably in electrical communication with one another to provide encapsulated circumferential protection to the elongate members (not shown) against any unwanted EMI, RFI, and/or ESD. Accordingly, the sleeve 110 provides EMI shielding, RFI shielding and/or ESD shielding to the elongate members contained within a cavity of the sleeve 110.

In addition, the sleeve 110 preferably has at least one drain wire 30 oriented lengthwise parallel to the longitudinal axis 20 of the sleeve 10. The drain wire 30 is preferably interlaced at a plurality of axially spaced locations along an inner surface of one of the walls 112, 114, 116, shown here, for example, as the lower wall 112. The drain wire 30 is interlaced along an inner surface 32 so that it is not exposed on an outer surface 34 of the wall 112, and thus, the drain wire 30 does not cause interference, electrical or otherwise, with surrounding components. In addition, as a result of not be exposed to the outer surface 34, a coating, represented generally at 36, such as a dielectric coating, thin film or other substrate, such as silicone rubber, acrylic, ceramic, PET, PVC, or some other suitable coating, could be applied uniformly to the outer surface 34 of the walls 112, 114, 116 without affecting the mobility of the drain wire 30. The coating 36 can further protect the elongate members 11 against fluid, EMI, ESD, RFI, arcing, shorting, abrasion, and heat from the surrounding components and environment. The drain wire 30 can be provided having any suitable diameter, and is generally about 18-24 gage, and of any suitable metal, such as twisted strands of tin coated copper, or stainless steel, for example.

The sleeve 110, though constructed utilizing the same weave patterns discussed above, thereby causing the walls 112, 114, 116 to automatically self-fold in overlying relation to one another, can be provided with a fastener 38 to secure the walls 112, 114, 116 in their overlapping relation with one another. The fastener 38 is represented here, by way of example and without limitation, as securing the upper and intermediate walls 114, 116 to one another. The fastener 38 can be provided as an adhesive, such as an adhesive strip, as shown here (with release paper still covering an adhesive layer), or snaps, hooks and loops, a zipper, tape, heat melt adhesive monofilaments, or an electrically conductive adhesive incorporating conductive particulate (silver, copper, aluminum, nickel, or carbon, for example), which further enhances the EMI, RFI, ESD shielding effectiveness of the sleeve. It should be recognized that other suitable fasteners could be used, and that the fasteners 38 could be directly attached to the lower and upper walls 112, 114, rather than between the upper and intermediate walls 114, 116, as shown.

Another aspect of the invention includes a method of constructing the sleeves 10, 110. The method comprising the steps of: weaving a plurality of yarn filaments extending along a warp direction corresponding to a length of the sleeve 10, 110 with a plurality of yarn filaments extending along a fill direction generally perpendicular to the warp direction, and forming living hinge regions 17, 18, 117, 118 with at least some of the yarn filaments during the weaving step. The forming of the living hinge regions 17, 18, 117, 118 is performed to connect the lower, upper and intermediate walls 12, 14, 16, 112, 114, 116 for biased, self folding movement over one another. In addition, the method optionally further includes using conductive material as a constituent of at least some of the plurality of yarn filaments, as described above. Further, the method optionally further includes interlacing the drain wire 30 in at least one of the lower, upper, or intermediate walls so that the drain wire 30 is exposed on an inner surface of the sleeve 10, 110 but preferably not externally of the sleeve 10, 110. In addition, the method optionally further includes applying the coating 36 to the outer surface of the sleeve 10, 110. It should be recognized that additional steps in accordance with the invention can also be performed, and are considered to be within the scope of the invention. For example, the sleeves 10, 110 described above can be constructed in line with the elongate members 11 so that the elongate members can be disposed within the sleeve 10, 110 as it is woven. Accordingly, a sleeve and elongate member assembly can be constructed in a single process.

It is to be understood that other embodiments which accomplish the same function are incorporated herein within the scope of any ultimately allowed patent claims.

What is claimed is:

1. An elongate textile sleeve for protecting elongate members, comprising:
a lower wall woven with a plurality of yarn filaments;
an upper wall woven with a plurality of yarn filaments; and
a woven hinge region extending along a length of said sleeve and connecting said lower wall to said upper wall, said hinge region having a portion woven with an imbalanced weave pattern, said imbalanced weave pattern creating a bias between said upper wall and said lower wall, said bias moving said upper wall into at least partially overlying relation with said lower wall.

2. The textile sleeve of claim 1 further comprising an intermediate wall and another woven hinge region, said another hinge region extending along a length of said sleeve and connecting said lower wall to said intermediate wall, said another hinge region having a portion woven with an imbalanced weave pattern, said imbalanced weave pattern creating a bias between said intermediate wall and said lower wall, said bias moving said intermediate wall into at least partially overlying relation between said lower wall and said upper wall.

3. The textile sleeve of claim 2 wherein said lower wall, said intermediate wall, said upper wall, and both of said hinge regions are woven at least in part from same yarns filaments.

4. The textile sleeve of claim 2 wherein at least some of said plurality of yarn filaments of said lower wall, said intermediate wall and said upper wall are formed with metallic material.

5. The textile sleeve of claim 1 wherein said lower wall, said upper wall and said hinge region are woven at least in part from the same continuous yarn filaments.

6. The textile sleeve of claim 1 wherein at least some of said plurality of yarn filaments of said lower wall and said upper wall are formed with metallic material.

7. The textile sleeve of claim 6 further comprising a drain wire interlaced within at least one of said lower or upper walls and in electrical communication with said metallic material.

8. The textile sleeve of claim 1 further comprising a fastener for securing said upper and lower walls to one another.

9. The textile sleeve of claim 1 wherein said imbalanced weave pattern is a herringbone weave.

10. The textile sleeve of claim 1 wherein said imbalanced weave pattern is a satin weave.

11. The textile sleeve of claim 1 wherein said woven hinge region has a pivot portion extending along a length of said woven hinge region, said pivot portion being woven in a balanced weave pattern and separating opposite imbalanced weave patterns of said woven hinge region.

12. The textile sleeve of claim 11 wherein said opposite imbalanced weave patterns are woven with a same weave pattern.

13. The textile sleeve of claim 12 wherein said opposite imbalanced weave patterns are a herringbone weave.

14. The textile sleeve of claim 12 wherein said imbalanced weave patterns are a satin weave.

15. The textile sleeve of claim 11 wherein said balanced weave pattern is a plain weave.

16. The textile sleeve of claim 11 wherein said balanced weave pattern is a twill weave.

17. The textile sleeve of claim 1 wherein said upper wall is woven at least in part using a balanced twill weave.

18. The textile sleeve of claim 2 wherein said another woven hinge region has a pivot portion extending along a length of said another woven hinge region, said pivot portion being woven in a balanced weave pattern and separating opposite imbalanced weave patterns of said another woven hinge region.

19. The textile sleeve of claim 18 wherein said opposite imbalanced weave patterns are woven with different weave patterns.

20. The textile sleeve of claim 19 wherein one of said opposite imbalanced weave patterns is a warp-faced weave and the other of said opposite imbalanced weave patterns is a weft-faced weave.

21. The textile sleeve of claim 20 wherein one of said opposite imbalanced weave patterns is woven with the same weave as said lower wall.

22. The textile sleeve of claim 2 wherein said lower wall is woven with an imbalanced weave pattern and said intermediate and upper walls are woven at least in part with a balanced weave pattern.

23. A method of constructing a self-folding textile sleeve for protecting elongate members, comprising the steps of:
weaving a plurality of yarn filaments extending along a warp direction corresponding to a length of the sleeve and a plurality of yarn filaments extending along a fill direction generally perpendicular to said warp direction; and
forming a living hinge with at least some of said yarn filaments during the weaving step, said living hinge connecting said lower and upper walls and biasing said walls into self folding movement over one another.

24. The method of claim 23 further including using conductive material as a constituent of at least some of said plurality of yarn filaments.

25. The method of claim 24 further including interlacing a drain wire in one of said upper and lower walls.

26. A method of constructing sleeve assembly having generally flat lower and upper walls overlying one another in a generally low-profile for protecting generally flat elongate members against at least one of abrasion, high temperatures, EMI, RFI or ESD, comprising the steps of:
weaving a plurality of yarn filaments extending along a warp direction corresponding to a length of the sleeve and a plurality of yarn filaments extending along a fill direction generally perpendicular to said warp direction;
forming a living hinge with at least some of said yarn filaments during the weaving step, said living hinge connecting said lower and upper walls and biasing said walls into self folding movement over one another; and
disposing the elongate member in the sleeve during the weaving step.
